(19) United States
(12) Patent Application Publication
(10) Pub. No.: US 2013/0108867 A1
(43) Pub. Date: May 2, 2013

(54) METHYLENEBIS (FATTY ACID AMIDE) COMPOSITION, ADHESIVE SHEET, AND METHOD FOR MANUFACTURING THEREOF

(71) Applicants: Shigeki Ishiguro, Ibaraki-shi (JP); Takumi Yutou, Ibaraki-shi (JP); Hiroki Senda, Ibaraki-shi (JP); Masamichi Matsumoto, Ibaraki-shi (JP); Yuka Sekiguchi, Ibaraki-shi (JP); Aya Nagatomo, Ibaraki-shi (JP); Yuji Okawa, Ibaraki-shi (JP); Fumiteru Asai, Ibaraki-shi (JP); Michihito Ooishi, Ibaraki-shi (JP); Toshimasa Sugimura, Ibaraki-shi (JP)

(72) Inventors: Shigeki Ishiguro, Ibaraki-shi (JP); Takumi Yutou, Ibaraki-shi (JP); Hiroki Senda, Ibaraki-shi (JP); Masamichi Matsumoto, Ibaraki-shi (JP); Yuka Sekiguchi, Ibaraki-shi (JP); Aya Nagatomo, Ibaraki-shi (JP); Yuji Okawa, Ibaraki-shi (JP); Fumiteru Asai, Ibaraki-shi (JP); Michihito Ooishi, Ibaraki-shi (JP); Toshimasa Sugimura, Ibaraki-shi (JP)

(73) Assignee: NITTO DENKO CORPORATION, Ibaraki-shi, Osaka (JP)

(21) Appl. No.: 13/809,047

(22) PCT Filed: Jul. 7, 2011
(86) PCT No.: PCT/JP2011/065535

§ 371 Date: Jan. 8, 2013

(30) Foreign Application Priority Data
Jul. 9, 2010 (JP) 2010-156619
Jul. 20, 2010 (JP) 2010-162736

(51) Int. Cl. C09J 11/06

(52) U.S. Cl. CPC C09J 11/06
USPC 428/355 AC; 428/343; 428/355 R; 156/242; 554/37

(57) ABSTRACT

The present invention provides a methylenebis(fatty acid amide) composition containing as a main component a methylenebis(fatty acid amide) obtained by reacting a fatty acid monoamide with formaldehyde, a content of impurities which consist of the fatty acid monoamide and a fatty acid from which the fatty acid monoamide is constituted is 0 to less than 2 wt %, and a adhesive sheet containing the methylenebis(fatty acid amide) composition.

### TECHNICAL FIELD

The present invention relates to a methylenebis(fatty acid amide) composition, adhesive sheet, and method for manufacturing thereof, and more specifically to a methylenebis(fatty acid amide) composition that is suitable for use in manufacturing an adhesive sheet, an adhesive sheet that is provided with layers that contain said composition, and a method for manufacturing thereof.

### BACKGROUND ART

Conventionally, PVC films and the like have been used as a substrate layer for re-releasable adhesive sheets in semiconductor manufacturing processes, and the like. Adhesive sheets are constructed by applying an adhesive layer to one surface of the substrate layer comprising such PVC films, the unwinding and adhesion thereof to the adherend can be controlled by adding a fatty acid amide in the substrates and adhesives, and by suitably bleeding the fatty acid amide onto the adhesive surface (for example, Japanese Unexamined Patent Publication No. S57-139163).

In addition, it has been proposed that good release characteristics and antifouling properties can be obtained by adding urea compounds and hydrotalcite to vinyl chloride resin (for example, Japanese Unexamined Patent Publication No. H7-276516).

However, their adhesion characteristics are not stable at the present, and moreover there is significant contamination of the adherend such as semiconductor wafers and the like at release of the adhesive sheet. In particular, depending on the storage conditions for the adhesive sheet, the storage conditions for the adhesive sheet after bonding to the adherend, and the like, defects occur while releasing the adhesive sheet from the adherend that can make release difficult or can result in residual contamination by adhesive or the like in the adherend.

### SUMMARY OF THE INVENTION

### Problem to be Solved by the Invention

Taking account of the aforementioned problem, the present invention has the goal of providing a methylenebis(fatty acid amide) composition, adhesive sheet, and method for manufacturing thereof that can offer stable adhesive characteristics and release characteristics in a variety of environments, as well as minimizing contamination of the adherend.

### Means for Solving the Problem

From the results of diligently performed research on the adhesive characteristics and release characteristics of current re-releasable adhesive sheets, the present inventors discovered that numerous impurities derived from starting materials and side products during the synthesis were present in methylenebis(fatty acid amide)s which are contained in the substrate layer or adhesive layer of the adhesive sheet as additives, and moreover the quantities of impurities exhibited significant variation in each production lot in their commercial products. They then discovered that when the impurities have been removed from methylenebis(fatty acid amide)s and these same were added to the substrate layer or the adhesive layer, it was unexpectedly possible to stabilize the adhesive characteristics, and reduce contamination of the adherend substantially during release, thus accomplishing the present invention.

That is, the methylenebis(fatty acid amide) composition of the present invention contains as a main component a methylenebis(fatty acid amide) obtained by reacting a fatty acid monoamide with formaldehyde,

a content of impurities which consist of the fatty acid monoamide and a fatty acid from which the fatty acid monoamide is constituted is 0 to less than 2 wt %.

It is preferable that

(1) the methylenebis(fatty acid amide) is a compound represented by Formula (I);

R¹—Am—CH₂—Am—R² (I)

(where in the formula, R¹ and R² independently from one another represent a C₆-C₂₃ saturated or unsaturated hydrocarbon group, and Am represents a secondary amide group), or

(2) the methylenebis(fatty acid amide) obtained by reacting the fatty acid monoamide with formaldehyde is one in which impurities which consist of the fatty acid monoamide and the fatty acid from which the fatty acid monoamide is constituted are removed by extraction using a solvent that dissolves the fatty acid monoamide and the fatty acid and does not dissolve the methylenebis(fatty acid amide).

Further, the adhesive sheet of the present invention is formed from a thermoplastic resin film on one surface of which is formed a pressure-sensitive adhesive layer, either of the thermoplastic resin film or the pressure-sensitive adhesive layer contains the above methylenebis(fatty acid amide) composition.

The adhesive sheet preferably has any one of that

(1) the methylenebis(fatty acid amide) composition is added at 0.1-3.0 parts by weight based on 100 parts by weight of the thermoplastic resin,

(2) the thermoplastic resin film is a film made of polyvinyl chloride,

(3) the thermoplastic resin film further contains an ester plasticizing agent,

(4) the pressure-sensitive adhesive layer contains an acrylic polymer as a base polymer,

(5) the pressure-sensitive adhesive layer further contains an ester plasticizing agent,

(6) the adhesive sheet has an adhesive force toward a silicon wafer of a variable value of within ±0.5 N/20 mm of an initial value after storage.

Moreover, the method for manufacturing an adhesive sheet of the present invention has;

obtaining a methylenebis(fatty acid amide) composition in which the methylenebis(fatty acid amide) obtained by reacting a fatty acid monoamide with formaldehyde is purified by washing with a solvent that dissolves the fatty acid monoamide and a fatty acid from which the fatty acid monoamide is constituted and does not dissolve the methylenebis(fatty acid amide),

forming a thermoplastic resin film or a pressure-sensitive adhesive layer by adding the methylenebis(fatty acid amide) composition as an additive to a resin, and

laminating the thermoplastic resin film and the pressure-sensitive adhesive layer.

### Effects of the Invention

According to the present invention, it is possible to provide a methylenebis(fatty acid amide) composition, adhesive sheet, and method for manufacturing thereof that can offer stable adhesive characteristics and release characteristics in a variety of environments, as well as minimizing contamination of the adherend.

### Mode for Carrying out the Invention

[Methylene bis(fatty acid amide) Composition]

The methylene bis(fatty acid amide) composition of the present invention contains as a main component a methylenebis(fatty acid amide) obtained by the reaction of a fatty acid amide with formaldehyde. The methylene bis(fatty acid amide) can be a single component, or can be a mixture of 2 or more components. Here, “main component” means the component of the composition that is present in the largest weight.

In the methylene bis(fatty acid amide) composition of the present invention, the content of impurities that consist of the fatty acid monoamide and a fatty acid from which the fatty acid monoamide is constituted and are attributed to the starting material of the manufacture are kept to 0 to less than 2 wt % of the entire composition, and preferably kept to 0 to less than 1 wt %. The fatty acid monoamide and the fatty acid from which the fatty acid monoamide is constituted can respectively be not only single substances, but can also be mixtures of 2 or more substances, and in the latter case, the total content of these will be less than 2 wt %, and preferably less than 1 wt %. In other words, this means that the methylenebis(fatty acid amide) composition of the present invention contains substantially no impurities consisting of the fatty acid monoamide and the fatty acid from which the fatty acid monoamide is constituted.

Here, “contains substantially no . . . ” means that in a common analytical instrument (liquid chromatography system, high-performance liquid chromatography system, or the like), whether the content of a single substances or multiple substances of the fatty acid monoamide and fatty acid are respectively less than 0.5 wt %, preferably less than 0.4 wt %, less than 0.25 wt %, less than 0.2 wt %, less than 0.1 wt %, less than 0.05 wt %, or are measured to be below the detection limit, or preferably even in the case of multiple substances, the total content will be less than 2 wt %, preferably less than 1.6 wt %, less than 1 wt %, also preferably 0.8 wt % or less, 0.5 wt % or less, 0.4 wt % or less, 0.3 wt % or less.

Furthermore, the methylene bis(fatty acid amide) composition of the present invention can contain components other than the abovementioned impurities, for example, side components such as the tris-form of the fatty acid amide coming from the starting material. It is preferable that essentially none of such tris-forms be contained.

The methylenebis(fatty acid amide) composition of the present invention can be represented, for example, by formula (I)

R¹—Am—CH₂—Am—R² (I)

(where in the formula, R¹ and R² independently from one another represent a C₆-C₂₃ saturated or unsaturated hydrocarbon group, and Am represents a secondary amide group.)

Examples of compounds represented by Formula (I) include the compounds represented by Formula (II) or Formula (III).

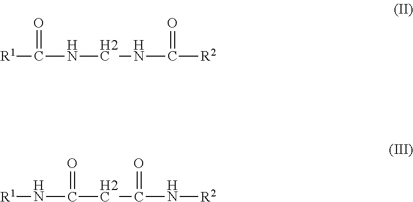

(where in the formula, R¹ and R² independently from one another represent a C₆-C₂₃ saturated or unsaturated hydrocarbon group.)

Furthermore, the compounds represented by Formula (II) or Formula (III) can, respectively, be of a single substances or a mixture of 2 or more substances, and mixtures of a compound represented by Formula (II) and a compound represented by Formula (III) are also satisfactory. In addition, in Formula (I) to Formula (III), R¹ and R² can be different from one another, but they are preferably the same.

Among them, the compounds represented by Formula (II) are preferred.

Examples of compounds represented by Formula (II) preferably include the compounds represented by Formula (IV).

CH₃—(CH₂)ₙ—CO—NH—CH₂—NH—CO—(CH₂)ₘ—CH₃ (IV)

(where in the formula, n and m independently from one another represent a integer of 5 to 22.)

The saturated or unsaturated hydrocarbon group includes linear, branched chain, cyclic and a combination thereof.

Examples of the saturated hydrocarbon group include a linear alkyl group such as methyl, ethyl, propyl, isopropyl, n-butyl, sec-butyl, t-butyl, pentyl, hexyl, octyl, decyl, dodecyl, tetradecyl, hexadecyl, octadecyl; a branched chain alkyl group such as ethylhexyl, ethyloctyl, propylhexyl; a cyclic alkyl group such as cyclopentyl, cyclohexyl, cycloheptyl, cyclopentenyl, cyclohexenyl, and the like.

Examples of the unsaturated hydrocarbon group include an alkenyl group such as a propenyl, isopropenyl, 2-propenyl, 9-octadecenyl group and the like.

In Formula (I) to Formula (III), the carbon number is preferably 8 to 20, and more preferably 10 to 18, and the saturated hydrocarbon group is preferable.

In Formula (IV), n and m are preferably 7 to 19 of the carbon number, more preferably 9 to 17, and still more 11 to 17 or 13 to 15.

The secondary amide group in Formula (I) means divalent amide group, and the carbon atom in the amide group may bond to any methylene group of R¹ or R².

Examples of the compound represented by the formula (II) include: N,N′-methylene biscapric acid amide, N,N′-methylene bislauric acid amide, N,N′-methylene bismyristic acid amide, N,N′-methylene bisparmitic acid amide, N,N′-methylene bisoleinic acid amide, N,N′-methylene bisstearic acid amide, N,N′-methylene bisbehenic acid amide, N,N′-methylene biserucic acid amide, and the like.

Examples of the compound represented by the formula (III) include: N,N′-dicapryl malonic acid amide, N,N′-dilauryl malonic acid amide, N,N′-dimyristyl malonic acid amide, N,N′-diparmityl malonic acid amide, N,N′-dioleyl malonic acid amide, and N,N′-distearyl malonic acid amide, N,N′-dibehenyl malonic acid amide, and N,N′-dierucaryl malonic acid amide, and the like.

Among them, N,N′-methylene bisstearic acid amide, N,N′-methylene bis palmitic acid amide, or a mixture thereof are preferable, and a mixture of N,N′-methylene bisstearic acid amide and N,N′-methylene bispalmitic acid amide are more preferable. In a case of mixture, the content of the mixture of N,N′-methylene bisstearic acid amide and N,N′-methylene bispalmitic acid amide is preferably N,N′-methylene bisstearic acid amide:N,N′-methylene bispalmitic acid amide=about 1 to 10:10 to 1, and more preferably about 5 to 8:2 to 5.

Usually, methylenebis(fatty acid amide)s are produced by the reaction of a fatty acid amide and formaldehyde. Additionally, fatty acid amides are prepared industrially by the reaction of a fatty acid with ammonia.

2R—CO—NH₂+HCHO→R—CO—NH—CH₂—NH—CO—R

R—CO—NH₂+HCHO→R—CO—NH—CH₂OH

(where in the formula, R represents saturated or unsaturated hydrocarbon group.)

Furthermore, depending on the synthesis methods and/or conditions, the methylenebis(fatty acid amide)s such as R—NH—CO—CH₂—CO—NH—R can be obtained.

However, not only are bis fatty acid amides produced, but also are mono fatty acid amides in the abovementioned manufacturing method, depending on the manufacturing conditions, the degree of purity of the methylenebis(fatty acid amide) can change, and thus the purity cannot be closely controlled during the industrial process. Actually, when the purity of the methylenebis(fatty acid amide)s in commercial products was analyzed, as shown below, it was confirmed that many impurity components were contained, and there is significant variability in each production lot.

Methylene bisstearic acid amide/methylene bispalmitic acid amide total about 70%,

Stearic acid amide 1 to 4%,

Palmitic acid amide 0.5 to 1.5%,

Stearic acid 1 to 5%,

Palmitic acid 0.5 to 1.5%,

trisamide about 20%.

In this way, theoretically, the composition comprising methylenebis(fatty acid amide) in extremely high purity can exist by purifying one which is obtained from the reaction of the fatty acid amide and formaldehyde, but in practical terms, the methylenebis(fatty acid amide) composition that contains substantially no impurities does not exist as an industrial product.

On the other hand, the methylenebis(fatty acid amide) composition of the present invention can be used as is without the need for any purification in the manufacture of adhesive sheets (in particular, as an additive for the substrate layer and/or the adhesive layer for the adhesive sheet) without impeding its intended action, to provide conditions in which the manufacture of adhesive sheets with high quality and characteristics can be realized.

To this end, the methylenebis(fatty acid amide)s obtained from the reaction of the fatty acid amide and formaldehyde is purified by subjection to washing or extraction, or the like, with a predetermined solvent.

The solvent would be suitable if, when used, it dissolved the fatty acid amide used as starting material, and furthermore dissolved the fatty acid used as starting material for the fatty acid amide, but did not dissolve the methylenebis(fatty acid amide). Here, “to dissolve” means that 10 g or less of the solvent is required to dissolve 1 g of solute, and “not to dissolve” means that 100 g or more of the solvent is required to dissolve 1 g of solute.

Examples of the solvent include chloroform, lower alcohol and these mixed solvents. Here, lower alcohol are suitable a lower alcohol with the carbon number of about 1 to 6, preferably about 1 to 4, and more preferably about 1 to 3. Specific examples thereof include methanol, ethanol, n-propanol, isopropanol, n-butanol, sec-butanol, tert-butanol, and the like. Among them, methanol, ethanol, isopropanol are preferable. These may be used at normal temperature, and preferably used at temperature heated of the degree not to evaporate. A heated ethanol, a heated methanol, a heated isopropanol are more preferable.

Here, “washing or extraction” can mean the use of any method generally known to the art. For example, the washing method wherein the methylenebis(fatty acid amide) obtained by the reaction of fatty acid amide and formaldehyde is immersed in a solvent, the method wherein the methylenebis(fatty acid amide) obtained is extracted in a Soxhlett apparatus using the solvent, and the like. Without being limiting in any particular way, the conditions in these cases, for example, would involve adding 30- to 100-fold by volume or by weight of the solvent based on the methylenebis(fatty acid amide), and carrying out the immersion, permeation, washing, extraction, or the like, for from 30 minutes to approximately several hours. Depending on the type of solvent used, the solvent can also optionally be heated to from room temperature to approx. 100° C. In addition, according to need, such procedures can optionally be repeated multiple times. The insoluble matter obtained can be separated by means known in the art, such as filtration or the like. After the washing or extraction, the insoluble matter obtained is preferably dried. The drying can be carried out by the use of the methods normally employed in the corresponding field. Without being limiting in any particular way, it is preferable for the drying conditions and temperature to be suitably adjusted.

Specifically, in the case of chloroform extraction, for example, 40 mL chloroform is added to approximately 1 g of commercial methylenebis(fatty acid amide), and after permeation for 1 hour using a solvent saturator, the insoluble fraction can be separated from the soluble fraction using suction filtration. Optionally, the chloroform-insoluble fraction obtained can be resubjected to the same procedure twice more to obtain a purified methylenebis(fatty acid amide) composition.

Moreover, in the case of ethanol extraction, for example, 40 mL ethanol is added to approximately 1 g of commercial methylenebis(fatty acid amide), and extraction was carried out with heating to 80° C. (hot plate temperature) for 1 hour. Afterward, the supernatant (soluble fraction) and the precipitate (insoluble fraction) are separated, and optionally the ethanol-insoluble fraction obtained can be resubjected to the same procedure twice more to obtain a purified methylenebis(fatty acid amide) composition.

From another perspective, the present invention provides a method for manufacturing a composition that contains purifying the methylenebis(fatty acid amide) with subjection to washing or extraction as mentioned above. Additionally, a method for using the purified the methylenebis(fatty acid amide), a method for manufacturing an adhesive sheet (substrate layer and/or adhesive layer) using this composition, and the like can be provided.

The impurity that is substantially not contained in the methylenebis(fatty acid amide) composition of the present invention, as mentioned above, includes the fatty acid that is attributed to the starting material, in other words, corresponding to what is described above, such as capric acid, stearic acid, oleic acid, erucic acid, laurylic acid, palmitic acid, myristic acid, behenic acid, or the like is contained. Particularly, it is preferable for stearic acid, oleic acid, palmitic acid, and the like not to be contained, and it is more preferable for stearic acid, palmitic acid, and the like not to be contained.

Additionally, as an impurity that is substantially not contained, as mentioned above, includes the fatty acid monoamide that is attributed to the starting material, corresponding to what is described above, in other wards, such as lauric acid monoamide, stearic acid monoamide, oleic acid monoamide, erucic acid monoamide, caprinic acid monoamide, palmitic acid monoamide, myristic acid monoamide, behenic acid monoamide, N-oleyl stearic acid monoamide, N-oleyl oleic acid monoamide, N-stearyl stearic acid monoamide, N-stearyl oleic acid monoamide, N-oleyl palmitic acid monoamide, N-stearyl erucic acid monoamide, and the like. Particularly, it is preferable for stearic acid monoamide, palmitic acid monoamide, and the like not to be contained.

[Adhesive Sheet]

The adhesive sheet of the present invention is formed from a thermoplastic resin film as the substrate layer and a pressure-sensitive adhesive layer which is formed on one surface thereof. The methylenebis(fatty acid amide) composition that substantially does not contain the substantially specific impurities mentioned above is contained as an additive in either of the thermoplastic resin film or pressure-sensitive adhesive layer.

The methylenebis(fatty acid amide) composition can also be contained in both the thermoplastic resin film and pressure-sensitive adhesive layer. As mentioned later, when the thermoplastic resin film and/or the pressure-sensitive adhesive layer has a laminate structure, it can be contained in a single layer from among them, or it is preferably contained in a layer that is in contact with both the thermoplastic resin film and the pressure-sensitive adhesive layer.

Consequently, in the adhesive sheet of the present invention, for either the thermoplastic resin film that is the substrate layer or the pressure-sensitive adhesive layer, it is preferable not to contain the fatty acid monoamide and the fatty acid that are attributed to the manufacturing starting material of the methylenebis(fatty acid amide) composition that is added as an additive.

The amount added of additive in the thermoplastic resin film of the methylenebis(fatty acid amide) composition, for example, is preferably 0.1-3.0 parts by weight based on 100 parts by weight of the thermoplastic resin in the thermoplastic resin film. The amount added of additive in the pressure-sensitive adhesive layer of the methylenebis(fatty acid amide) composition, for example, is preferably 0.1-3.0 parts by weight based on 100 parts by weight of a base polymer described later.

When the methylenebis(fatty acid amide) composition is added to both the thermoplastic resin film and the pressure-sensitive adhesive layer, the total amount added is suitably adjusted so as to be in the range of 0.1-3.0 parts by weight based on 100 parts by weight of the thermoplastic resin.

(Thermoplastic Resin Film)

There is no particular limitation in relation to the thermoplastic resin film of the present invention, and for example, a film made of polyolefins such as low-density polyethylene, linear polyethylene, medium-density polyethylene, high-density polyethylene, very low-density polyethylene, random copolypropylene, block copolypropylene, homopolypropylene, polybutene, polymethylpentene; polyolefin-base resin such as ethylene-vinyl acetate copolymer, ionomer resin, ethylene-(meth)acrylic acid copolymer, ethylene-(meth)acrylic ester (random, alternating) copolymer, ethylene-butene copolymer, ethylene-hexene copolymer; polyester-base resin such as polyurethane, polyethylene terephthalate, polyethylene naphthalate; (meth)acrylic polymer, polystylene, polycarbonate, polyimide, polyamide, polyamideimide, polyetherimide, polysulfon, polyethersulfon, polyvinyl chloride, polyvinylidene chloride, fluorocarbon resin, cellulosic resin or cross-linked polymer thereof. The thermoplastic resin may be blended two or more as needed. Among them, polyvinyl chloride-based resin is preferable.

Examples of the polyvinyl chloride-based resin include polyvinyl chloride, a polyvinyl chloride copolymer, a polyvinyl chloride graft copolymer, a blended polymer of polyvinyl chloride.

Examples of a comonomer for polyvinyl chloride copolymer include, for example, vinyl esters such as vinyl acetate; vinyl ethers such as ethyl vinyl ether; α-olefines such as ethylene, propylene, 1-butene; (meth)acrylates such as methyl acrylate, ethyl acrylate, methyl methacrylate, butyl methacrylate; polyvinylidene chloride.

The thermoplastic resin film preferably includes a plasticizing agent so that the resulting adhesive sheet exhibits a suitable level of flexibility. In addition, an additive such as a stabilizer, a filler, a colorant, a UV absorbing agent, an antioxidant, or the like may be added as required.

There is no particular limitation in relation to the plasticizing agent, and for example, phthalates, trimellitates (trioctyl trimellitate, W-700, DIC corpolation), adipates (dioctyl adipate, diisononyl adipate, D-620, J-PLUS Co., Ltd.), phosphates (tricresyl phosphate), adipic acids esters, citrates (acetyl tributyl citrate), sebacates, azelates, maleates, benzoates, polyether polyesters, epoxypolyesters (epoxidazed soybean oil, epoxidazed linseed oil, and the like), polyesters (low molecular polyesters, and the like made of carboxylic acid and glycol), and the like. These can be used alone or as mixture of two or more.

Among them, ester plasticizing agents are preferable.

The plasticizing agent may be suitably added in an amount of about 10 to about 60 parts by weight, and preferably about 10 to about 30 parts by weight relative to 100 parts by weight of a thermoplastic resin.

There is no particular limitation in relation to the stabilizer, and the stabilizer may include a barium-zinc based, a tin based, a calcium-zinc based, or a cadmium-barium based composite stabilizing agent, or the like.

The filler includes an inorganic filler such as calcium carbonate, silica, mica or the like, or a metal filler such as iron, lead or the like.

The colorant includes a pigment, a dye or the like.

Other additives include use of any additive known for use in this field.

The thermoplastic resin film may be a single-layer film, or may be a laminated film (multilayer film) exhibiting the advantages of respective resins including different materials or compositions.

The thickness of the thermoplastic resin film may be adjusted in relation to the physical properties of the target adhesive sheet or the like, and for example may fall within a range of about 30 to about 1000 μm, preferably about 40 to about 800μm, more preferably about 50 to about 500 μm, and further more preferably about 60 to about 200 μm.

The front and rear surfaces of the thermoplastic resin film, and in particular, the front surface, that is to say, the surface on the side provided with the adhesive layer, may be processed using a customary surface processing method, such as an oxidizing process or the like using a chemical or physical method such as corona processing, chromic acid processing, ozone exposure, exposure to a flame, exposure to high-voltage electric shock, ion irradiation processing, or the like in order to improve the adhesion with the adhesive agent.

(Pressure Sensitive Adhesive Layer)

The pressure sensitive adhesive (hereinafter may be simply referred to as “adhesive”) layer is formed from a pressure sensitive adhesive. There is no particular limitation in relation to the pressure sensitive adhesive, and for example a rubber adhesive, an acrylic adhesive, a polyamide adhesive, a silicone adhesive, a polyester adhesive, a polyurethane adhesive or the like may be used depending on the type of base polymer that forms the adhesive. Suitable selection may be made from such known adhesives. Of such adhesives, suitable use for the expression of desired characteristics may be enabled by selection of the type of monomer component that configures the acrylic polymer and exhibits superior performance in relation to various characteristics such as heat resistance, weather resistance or the like.

The acrylic adhesive is usually formed by a base polymer made from a main monomer component such as (meth)acrylic alkyl ester.

Examples of the (meth)acrylic alkyl ester include a C₁ to C₂₀ (preferably C₁ to C₁₂, and more preferably C₁ to C₈) alkyl (meth)acrylate such as methyl (meth)acrylate, ethyl(meth)acrylate, propyl(meth)acrylate, isopropyl(meth)acrylate, butyl(meth)acrylate, isobutyl(meth)acrylate, sec-butyl(meth) acrylate, tert-butyl(meth)acrylate, pentyl(meth)acrylate, hexyl(meth)acrylate, heptyl(meth)acrylate, octyl(meth)acrylate, 2-ethylhexyl(meth) acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, octadecyl(meth)acrylate, nonadecyl(meth)acrylate, eicosyl(meth)acrylate. The (meth)acrylic alkyl ester can be used alone or as mixture of two or more (meth)acrylic alkylesters.

The acrylic polymer may be a copolymer that is copolymerized with the (meth)acrylic alkyl ester and another copolymerizable monomer, as needed, for the purpose of modifying the cohesive force, heat resistance, cross linking property and the like.

Examples of such another monomer include;

a carboxyl group-containing monomer such as (meth)acrylic acid, carboxyethyl(meth)acrylate, carboxypentyl(meth)acrylate, itaconic acid, maleic acid, fumaric acid, crotonic acid;

a hydroxyl group-containing monomer such as hydroxybutyl(meth)acrylate, hydroxyhexyl(meth)acrylate, hydroxyoctyl(meth)acrylate, hydroxydecyl(meth)acrylate, hydroxylauryl(meth)acrylate, (4-hydroxymethyl cyclohexyl)methyl(meth)acrylate;

a sulfonate group-containing monomer such as styrenesulfonate, allylsulfonate, 2-(meth)acrylamide-2-methyl propanesulfonate, (meth)acrylamide propanesulfonate, sulfopropyl(meth)acrylate, (meth)acryloyl oxynaphthalenesulfonate;

a phosphate group-containing monomer such as 2-hydroxyethyl acryloyl phosphate;

an N-substituted amide monomer such as (meth)acrylic amide, N,N-dimethyl(meth)acrylic amide, N-butyl(meth)acrylic amide, N-methylol(meth)acrylic amide, N-methylolpropane(meth)acrylic amide;

an aminoalkyl(meth)acrylic monomer such as amino ethyl(meth)acrylate, N,N-dimethyl amino ethyl(meth)acrylate, t-butyl amino ethyl(meth)acrylate;

an alkoxy alkyl(meth)acrylic monomer;

maleimide monomer such as N-cyclohexylmaleimide, N-isopropylmaleimide, N-laurylmaleimide, N-phenylmaleimide;

an itaconimide monomer such as N-methyl itaconimide, N-ethyl itaconimide, N-butyl itaconimide, N-octyl itaconimide, N-2-ethylhexyl itaconimide, N-cyclohexyl itaconimide, N-lauryl itaconimide;

a succinimide monomer such as N-(meth)acryloyloxy methylene succinimide, N-(meth)acryloyl-6-oxy hexamethylene succinimide, N-(meth)acryloyl-8-oxy octamethylene succinimide;

a vinyl monomer such as vinyl acetate, vinyl propionate, N-vinyl pyrrolidone, methyl vinyl pyrrolidone, vinyl pyridine, vinyl piperidone, vinyl pyrimidine, vinyl piperadine, vinyl pyrazin, vinyl pyrrole, vinyl imidazole, vinyl oxazole, vinyl morpholine, N-vinyl carboxylic acid amide, styrene, a-metylstyrene, N-vinyl caprolactam;

a cyano acrylate monomer such as acrylonitrile, methacrylonitrile;

an epoxy group-containing acrylic monomer such as glycidyl(meth)acrylate;

a glycol acrylate monomer such as polypropylene glycol(meth)acrylate, methoxyethylene glycol(meth)acrylate, methoxypolypropylene glycol(meth)acrylate;

a heterocyclic-, halogen atom-, silicon-containing (meth)acrylate such as tetrahydro furfuryl(meth)acrylate, fluoro(meth)acrylate, silicon(meth)acrylate;

a multifunctional monomer such as hexanediol di(meth)acrylate, polyethylene glycol di(meth)acrylate, polypropylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy(meth)acrylate, polyester(meth)acrylate, urethane(meth)acrylate, divinylbenzene, butyl di(meth)acrylate, hexyl di(meth)acrylate;

an olefine monomer such as isoprene, dibutadiene, isobutylene;

a vinyl ether monomer such as vinyl ether.

These monomers can be used alone or as mixture of two or more monomers.

The acrylate copolymer can be produced by a conventional polymerization method with the above (meth)acrylic alkyl ester and other monomer as needed.

There is no particular limitation in relation to the molecular weight of the acrylic copolymer, for example, the weight-average molecular weight of the acrylic copolymer to be about 100,000 to about 2,000,000, about 150,000 to 1,000,000 is preferable, and about 300,000 to 1,000,000 is more preferable.

The adhesive may be configured as an energy-ray curable adhesive by adding an energy-ray polymerizable compound, or by introducing an energy-ray polymerizable double bonds into the base polymer. The adhesive layer that uses the energy-ray curable adhesive realizes sufficient adhesive force before irradiation with energy rays. Also, there is the possibility of a conspicuous reduction in adhesive force after irradiation with energy rays to thereby facilitate peeling without application of a stress to the adherend. The energy rays include for example ultraviolet rays, electron rays, or the like.

The energy-ray polymerizable compound includes a compound that has at least two energy-ray polymerizable carbon-carbon double bonds per molecule. The compound includes for example a multifunctional acrylate compound.

Examples of the multifunctional acrylate compound include;

a 1,4-butylenedi(meth)acrylate;

a linear aliphatic polyol(meth)acrylate such as 1,4-butylenediol di(meth)acrylate, 1,5-pentanediol di(meth)acrylate, 1,6-hexhandiol di(meth)acrylate, 1,9-nonanediol di(meth)acrylate, polyethylene glycol di(meth)acrylate, polypropylene glycol di(meth)acrylate;

an alicyclic group-containing aliphatic polyol(meth)acrylate such as cyclohexane dimethanol di(meth)acrylate, tricyclodecane dimethanol di(meth)acrylate;

a branched chain aliphatic polyol(meth)acrylate such as trimethylolpropane tri(meth)acrylate, pentaerythritol tri(meth)acrylate, pentaerythritol tetra(meth) acrylate;

a condensed compound thereof (di trimethylol propane teraacrylate, dipentaerythritol hexaacrylate, and the like).

These compounds can be used alone or as mixture of two or more compounds.

The multifunctional acrylate oligomer such as urethane acrylate oligomers can be used as the energy-ray polymerizable compound.

Urethane acrylate oligomer can be produced by reacting a hydroxy group-containing alkyl(meth)acrylic acid compound with urethane oligomer which is obtained by reacting diisocyanate with polyol compound.

Examples of diisocyanate include tolylenediisocyanate, diphenylmethane diisocyanate, hexamethylene diisocyanate, phenylene diisocyanate, dicyclohexylmethane diisocyanate, xylene diisocyanate, tetramethylxylene diisocyanate, naphthalene diisocyanate, isophorone diisocyanate.

Examples of polyol compound include a polyol such as ethylene glycol, 4-butanediol, 1,6-hexanediol, diethylene glycol, trimethylolpropane, dipropylene glycol, polyethylene glycol, polypropylene glycol, pentaerythritol, dipentaerythritol, glycerin;

a polyester polyol compound obtained by condensation reaction of the above polyol and an aliphatic dicarboxylic acid (e.g., adipic acid, sebacic acid, azelaic acid, maleic acid) or aromatic dicarboxylic acid (e.g., terephthalic acid, isophthalic acid);

a poly ether polyol compound such as polyethylene ether glycol, polypropylene ether glycol, polytetramethylene ether glycol, polyhexamethylene ether glycol;

a lactone polyol compound such as polycaprolactone glycol, polypropiolactone glycol, polyvalerolactone glycol;

a polycarbonate polyol compound obtained by dealcohol reaction of a polyol (e.g., ethylene glycol, propylene glycol, butanediol, pentanediol, octandiol, nonandiol) and a diethylene carbonate, dipropylene carbonate, or the like.

Examples of hydroxy group-containing (meth)acrylate alkyl ester compound include 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, (4-hydroxymethylcyclohexyl)methyl(meth)acrylate.

The energy-ray polymerizable compound may be suitably used in an amount of about 5 to about 200 parts by weight, preferably about 10 to about 100 parts by weight, and more preferably about 10 to about 45 parts by weight relative to 100 parts by weight of a base polymer.

The method of introducing energy-ray polymerizable double bonds into the base polymer includes for example a method in which a copolymerizable monomer including a reactive functional group such as a carboxyl group, a hydroxyl group, an amino group, or the like is subjected to copolymerization when preparing the acrylic polymer that forms the base polymer. In this manner, the functional group forming the base of the reaction can be introduced into the base polymer, and a functional monomer or an oligomer that includes energy-ray polymerizable carbon-carbon double bonds can be bonded through the functional group that forms the basis of the reaction. As a result, a base polymer can be obtained that includes energy-ray polymerizable carbon-carbon double bonds in a side chain.

The energy-ray curable adhesive may include a photopolymerization initiator as required. The photopolymerization initiator is excited and activated by irradiation with energy rays to form radicals and thereby promote an effective polymerization curing reaction in the adhesive layer.

Examples of the photopolymerization initiator include, for example,

a benzoine alkyleter photopolymerization initiator such as benzoine methyl ether, benzoine ethyl ether, benzoine isopropyl ether and benzoine isobutyl ether;

a benzophenone photopolymerization initiator such as benzophenone, benzoylbenzoate, 3,3′-dimethyl-4-methoxy benzophenone, polyvinyl benzophenone;

an aromatic ketone photopolymerization initiator such as a-hydroxy cyclohexylphenyl kethone, 4-(2-hydroxyethoxy)phenyl(2-hydroxy-2-propyl)ketone, α-hydroxy-α, α′-dimethylacetophenone, methoxyacetophenone, 2,2-dimethoxy-2-phenylacetophenone and 2,2-diethoxy acetophenone;

an aromatic ketal photopolymerization initiator such as benzyldimethyl ketal;

a thioxanthone photopolymerization initiator such as thioxanthone, 2-chlorothioxanthone, 2-methylthioxanthone, 2-ethylthioxanthone, 2-isopuropylthioxanthone, 2-dodecylthioxanthone, 2,4-dichlorothioxanthone, 2,4-dimethylthioxanthone, 2,4-diethylthioxanthone and 2,4-diisopropylthioxanthone;

a benzoyl photopolymerization initiator such as benzyl;

a benzoin photopolymerization initiator such as benzoin;

an α-ketol photopolymerization initiator such as 2-methyl-2-hydroxypuropiophenone; p an aromatic sulfonyl chloride photopolymerization initiator such as 2-naphthalene sulfonyl chloride;

a light-active oxime photopolymerization initiator such as 1-phenon-1,1-propanedione-2-(o-ethoxycarbonyl)oxime;

camphor quinine, ketone halide, acyl phosphinoxide and acyl phosphonate.

These compounds can be used alone or as mixture of two or more compounds.

The adhesive may include a polymer that has an acidic group such as a carboxyl group as a base polymer, and may include a hydrophilic adhesive that is imparted with hydrophilic properties by neutralization of all or a part of the acidic groups in the base polymer by addition of a neutralizing agent. The hydrophilic adhesive generally exhibits low residual glue on the adherend, and even in the event that residual glue is present, simple removal by washing in pure water is possible.

When preparing the base polymer, a polymer that includes an acidic group can be obtained by polymerization of monomers that have acidic groups such as a monomer that contains a carboxyl group as described above.

Examples of the neutralizing agent include a primary amine such as monoethylamine, monoethanolamine; a secondary amine such as diethylamine diethanolamine; a tertiary amine such as triethylamine, triethanolamine, N,N,N′-trimethyl ethylenediamine, N-methyldiethanolamine, N,N-diethylhydroxylamine, an organic amino compound with alkalinity.

The adhesive may contain a cross linking agent as required.

Examples of the cross linking agent include an epoxy-based cross linking agent, an isocyanate-based cross linking agent, a melamine-based cross linking agent, a peroxide-based cross linking agent, a metal alkoxide-based cross linking agent, a metal chelate-based cross linking agent, a metal salt-based cross linking agent, a carbodiimide-based cross linking agent, an oxazoline-based cross linking agent, an aziridine-based cross linking agent, an amine-based cross linking agent, and the epoxy-based cross linking agent and isocyanate-based cross linking agent are preferable. These compounds can be used alone or as mixture of two or more compounds.

Examples of the epoxy-based cross linking agent include, for example, N,N,N′,N′-tetraglycidyl-m-xylenediamine, diglycidylaniline, 1, 3-bis (N,N-glycidylaminomethyl) cyclohexane, 1, 6-hexandioldiglycidyleter, neopentyl glycol diglycidylether, ethylene glycol diglycidylether, propylene glycol diglycidylether, polyethylene glycol diglycidylether, polypropylene glycol diglycidylether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, diglycidyl adipate, diglycidyl o-phthalate, triglycidyl-tris(2-hydroxyethyl)isocyanurate, resorcin diglycidyl ether, bisphenol-S-diglycidyl ether, epoxy resin which has 2 or more epoxy group in its molecule.

Examples of the isocyanate-based cross linking agent include, for example, lower aliphatic polyisocyanates such as 1,2-ethylene diisocyanate, 1,4-butylene diisocyanate, 1,6-hexamethylene diisocyanate; aliphatic polyisocyanates such as cyclopentylene diisocyanate, cyclohexylene diisocyanate, isophorone diisocyanate, hydrogenation trilene diisocyanate, hydrogenation xylene diisocyanate; aromatic polyisocyanates such as 2,4-trilene diisocyanate, 2,6-trilene diisocyanate, 4,4′-diphenyl methane diisocyanate, xylylene diisocyanate.

The adhesive layer preferably contains a plasticizing agent. The plasticizing agent may be the same as those described above. The added amount of the plasticizing agent may be suitably determined using a proportion of about 10 to about 100 parts by weight, preferably about 10 to about 80 parts by weight, and more preferably about 10 to about 60 parts by weight relative to 100 parts by weight of a thermoplastic resin that configures the adhesive, that is to say, the base polymer.

The adhesive layer may also include an additive such as a stabilizer, a filler, lubricant, a colorant, a UV absorbing agent, an antioxidant, a dye or the like as required. These additives may be the same as those described above.

The adhesive layer may be formed by applying the adhesive described above onto a base material using a suitable method such as knife coating, roller coating, gravure coating, die coating, reverse coating, or the like. For example, an adhesive layer may be formed on a suitable casting process sheet such as a film surface processed using a mold release process, and then the adhesive layer may be transferred onto the thermoplastic film.

There is no particular limitation in respect of the thickness of the adhesive layer. A thickness of about 5 to about 100 μm is preferred, more preferably about 5 to about 60 μm, and in particular preferably about 5 to about 30 μm. When the thickness of the adhesive layer is within the above range, the stress applied to the thermoplastic resin film can be reduced, and it is possible to improve the stress relaxation rate of the adhesive sheet.

For example, regardless of the storage conditions, the adhesive sheet of the present invention has an adhesive force toward a silicon wafer that is preferably controlled to a variable value of within ±0.5 N/20 mm before and after storage. In other words, it preferably exhibits a variable value of adhesive force toward a silicon wafer of within ±0.5 N/20 mm of an initial value following storage. With such a range, a decrease in the adhesive force of the adhesive sheet can be prevented regardless of the conditions of storage, and it can readily be released from the adherend. As used herein, “before storage” means immediately after the manufacture of the adhesive sheet, or immediately after the attachment of the release liner to the side provided with the adhesive layer after the manufacture of the adhesive sheet. “After storage” normally means after approximately one week or more from the manufacture or from the attachment of the release liner to the side provided with the adhesive layer.

The adhesive sheet may be used for various applications. Examples of the application may include an adhesive sheet for fixing of wafers during semiconductor processing, of various members of products having a plate shape or curved surface formed from resin, glass, metal or the like, of film or optical devices; for back-grinding of semiconductors; for dicing of semiconductors; for dicing of semiconductor packages, glass, ceramics, or the like; or for protection of circuit surfaces during such processes.

In this way, through the use of the methylenebis(fatty acid amide) composition that contains substantially no impurities consisting of the fatty acid and the fatty acid mono amide attributable to the starting materials for the methylenebis(fatty acid amide), the adhesive sheet of the present invention unexpectedly resolves the defects when a commercial methylenebis(fatty acid amide) is used. In other words, regardless of the conditions of storage (in other words, due to storage or treatment at high temperatures), it is possible to obtain normally sufficient adhesive force. Furthermore, even when stored at a temperature of approx. 60° C. under conditions of being affixed to an adherend such as a silicon wafer (in other words, regardless of the storage conditions after being bonded to the adherend), when it is released from the adherend, it is possible to prevent defects such as difficulty in release due to an increase in adhesive force, adhesive residues on the adherend, or the like. Such defects are surmised to be the expression of the adhesive-like effect toward the adherend due to low-molecular-weight impurity components being precipitated in the form of liquid at the interface between the adherend and the adhesive, and later through crystallization upon the return to room temperature. Conversely, it is suggested that, if the amount of impurities such as low-molecular-weight components is to be reduced, migration of the methylene bis(fatty acid amide) is less likely to occur even when maintained at a certain level of high temperature, and variation in adhesive force over time is decreased.

(Release Liner)

The adhesive sheet of the present invention can include a release liner for protecting the adhesive layer, and the like.

The release liner may be a commonly used liner in this technical field, and may be used without any particular limitation thereon. For example, a base such as a film formed from paper; rubber; various foils such as aluminum foil, copper foil, stenless steel foil, iron foil, duralumin fiol, tin foil, titanium foil, gold foil; film made of various resins such as polyethylene, polypropylene, polyvinyl chloride, polyester, polyamide; foams such polyurethane foam, vinyl foam, polyethylene foam, stylene foam; nonwoven fabric; woven fabric; felt, or a laminate of these materials with a polymer material may be used as a base material.

There is no particular limitation on the thickness of the base material, it suitably falls within a range of about 5 μm to about 5 mm, and preferably about 30μm to about 100 μm.

The surface on the side that comes into contact with the adhesive layer in this type of base material may be die release treated by a known method in this technical field, which includes laminate coating of a die release agent such as a silicone-based resin, a long-chain alkyl-based resin, fluorine-based resin, low molecular weight polyethylene, polypropylene, a rubber-based polymer and a phosphate ester-based surface active agent, and the like.

The release liner may include one or a plurality of slits (in a so-called back cut configuration) that have a linear, waved, serrated or saw toothed shape to improve the adhesive operation performance when adhereing the adhesive sheet to an adherend.

[Manufacture of the Adhesive Sheet]

The adhesive sheet of the present invention includes;

obtaining a methylenebis(fatty acid amide) composition in which the methylenebis(fatty acid amide) obtained by reacting a fatty acid monoamide with formaldehyde is purified by washing with a solvent that dissolves the fatty acid monoamide and a fatty acid from which the fatty acid monoamide is constituted and does not dissolve the methylenebis(fatty acid amide),

forming a thermoplastic resin film or a pressure-sensitive adhesive layer by adding the methylenebis(fatty acid amide) composition as an additive to a resin, and

laminating the thermoplastic resin film and the pressure-sensitive adhesive layer.

Here the purified methylenebis(fatty acid amide) composition can be obtained as described above.

Moreover, the method itself in which this purified methylenebis(fatty acid amide) composition is added as an additive to the resin or the like, and the thermoplastic resin film or the pressure-sensitive adhesive layer is formed can utilize a method that is known in the art of this field.

Furthermore, the formation and lamination of the thermoplastic resin films or the pressure-sensitive adhesive layers can also be carried out sequentially. In other words, according to methods known in the art of this field, the thermoplastic resin films or the pressure-sensitive adhesive layers can also be formed independently of one another. For this purpose, for example, melt extrusion molding (inflation method, T-die method, and the like), melt-flow method, calendar method, and the like can be utilized. In addition, the adhesive layer can also be formed separately according to the abovementioned methods. In this way, when the thermoplastic resin film and the pressure-sensitive adhesive layer are formed independently, they can both be laminated using methods that are known in the art of this field.

The formation and lamination of the thermoplastic resin film or the pressure-sensitive adhesive layer can also be carried out at the same time. In other words, the thermoplastic resin film and the pressure-sensitive adhesive layer can be formed in a multilayer structure using the co-extrusion method, lamination method (extrusion/lamination method, lamination methods using an adhesive, or the like), or the heat seal method (external heating method, internal heat build-up method, or the like).

An adhesive sheet equipped with the release liner can be usually obtained by attaching the release liner to the adhesive side of the adhesive sheet after the adhesive sheer is formed.

### EXAMPLES

The present invention will now be described in detail on the basis of examples, but the present invention is not limited to these examples.

### Example 1

### Methylene bis(fatty acid amide) Composition and its Manufacture

First, different commercial production lots of methylene bis(fatty acid amide)s (1) and (2) (Nippon Kasei Chemical Co., Ltd.) were prepared.

The content of each component in these methylene bis(fatty acid amide)s (1) and (2) was measured using HPLC with the conditions given below. These results are shown in Table 1.

Next, the impurities in these methylenebis(fatty acid amide)s (1) and (2) comprising the fatty acid monoamide and the fatty acid that constitutes the fatty acid monoamide were removed. Specifically, 40 mL chloroform was added respectively to approx. 1 g of these methylenebis(fatty acid amide)s (1) and (2), and these were allowed to permeate for 1 hour in solvent saturators. Afterwards, the insoluble fraction and soluble fraction were separated using suction filtration. The chloroform-insoluble fractions obtained were respectively treated in the same manner twice more to obtain methylenebis(fatty acid amide)s that contained substantially no impurities.

Analysis of the impurities in the methylene bis(fatty acid amide) compositions was carried out as described below. These results are shown in Table 1.

First, approx. 0.5 g of the methylene bis(fatty acid amide) composition was taken, and this was immersed in a chloroform/acetonitrile solvent mixture in a solvent saturator for approx. 1 day, after which the supernatant was passed through a 0.45 μm membrane filter and then measured using an HPLC system (Waters W2695/W2420) as described below.

### Condition of HPLC

Column: Inertsil C8-3(4.6 mm×150 mm, 5 μm)

Flow rate: 1.0 ml/min

Detector: ELS

Column temperature: 40° C.

Injection amount: 30 μl

Grain: 30

Drift tube temperature: 50° C.

Gas pressure: 40 psi

Ingradient of eluant: Gradient(min) 0→20→40

A: 0.1% TFA aqueous solution A% 50→0→0

B: acetonitrile B% 50→100→100

TABLE 1

| | |
|---|---|
| methylenebis | methylenebis |
| (fatty acid | (fatty acid |
| amide) (1) | amide) (2) |
| Chloroform | Chloroform |
| extraction | extraction |
| (wt %) | (wt %) |

| | before | after | before | after |
|---|---|---|---|---|
| Palmitic acid | 0.9 | <0.05 | 0.5 | <0.02 |
| monoamide | | | | |
| Stearic acid | 2.8 | <0.05 | 1.7 | <0.03 |
| monoamide | | | | |
| Palmitic acid | 0.6 | <0.1 | 0.6 | <0.06 |
| Stearic acid | 1.2 | <0.06 | 1.1 | <0.03 |

### Example 2

### Adhesive Sheet and its Manufacture

A composition materials as described below were prepared and were blended in a Henschel mixer, a plasticizer was impregnated into the resin, and they were dried. This was kneaded in a Banbury mixer to obtain a polyvinyl chloride mixture, and then a thermoplastic resin film having a thickness of 110 μm was formed using with the obtained mixture and using a calendar film-forming apparatus.

Methylene bis(fatty acid amide) compositions were added during kneading using the Banbury mixer according to the proportions stated in the Examples and the Comparative Examples in Table 2.

| | |
|---|---|
| Thermoplastic resin: polyvinyl chloride resin | 100 parts by weight |
| (average degree of polymerization 1050) | |
| Plasticizer: Diethylhexyl phthalate | 30 parts by weight |
| Stabilizer: Ba—Zn mixed stabilizer | 3 parts by weight |
| Lubricant | 0.7 parts by weight |

The lubricants are the methylene bis(fatty acid amid) (1) which was one obtained after chloroform extraction in Example 1, the methylene bis(fatty acid amid) (1) which was one before chloroform extraction in Comparative Example 1, and the methylenbis(fatty acid amid) (1) which was one before chloroform extraction in Comparative Example 2.

The adhesive composition was prepared with the following composition.

| | |
|---|---|
| Acrylic polymer (butyl acrylate/acrylonitrile/acrylic | 100 parts by weight |
| acid = 84/14/2) | |
| Plasticizer: diethylhexyl phthalate | 20 parts by weight |
| Cross linking agent: butylated melamine resin | 10 parts by weight |

The resulting adhesive resin composition was diluted to 20% with toluene, and applied on the thermoplastic resin film described above to obtain a thickness of 10 μm after drying. After passing through a drying step for one minute at 150° C., it was rolled into a roll-shape.

Then aging was executed for 24 hours at 50° C., and then the adhesive layer adhered to a release liner (silicone processed polyester film, MRF, 38 μm (manufactured by Mitsubishi Plastics)) and rolled with the release liner.

The following evaluation was performed using the resulting adhesive sheet.

(1) Evaluation of Adhesive Force of Tape after Heating and Storing

After storage of the adhesive sheet with the release liner attached for one week in a drier at 60° C., test pieces were cut into a length of 100 mm and a width of 20 mm after leaving the sheet for one hour at room temperature, and then the adhesive force was measured under the following conditions.

Measurement Apparatus: Instron tensile test apparatus AUTOGRAPH AG-IS manufactured by Shimadzu Corporation

Measurement Atmosphere: 23° C., 50% RH

Adherend: 8-inch mirror wafer

Bonding Conditions: pressured by 2-kilograms Roller at one reciprocation

Measurement Conditions: 90° peel, 300 mm/min

Acceptability Determination: Pass grade for values within ±0.5 N/20 mm of initial value

(2) Evaluation of Adhesive Force when Heated and Stored after Bonding to Silicon Wafer

Test pieces having a length of 100 mm and a width of 20 mm were bonded to a silicon wafer, then they were stored for one week in a drier at 60° C., and the adhesive force was measured under the following conditions for them left for one hour at room temperature.

Measurement Apparatus: Instron tensile test apparatus AUTOGRAPH AG-IS manufactured by Shimadzu Corporation

Measurement Atmosphere: 23° C., 50% RH

Adherend: 8-inch mirror wafer

Bonding Conditions: pressured by 2-kilograms Roller at one reciprocation

Measurement Conditions: 90° peel, 300 mm/min

Acceptability Determination: Pass grade for values within ±0.5 N/20 mm of initial value.

(3) Evaluation of Wafer Surface Contamination Following the Adhesive Force Test

The post-adhesion to (contamination of) the wafer surface following the adhesive force test was evaluated according to the following criteria:

5: No post-adhesion

4: Entire surface observed to be hazy (not visible without looking carefully)

3: Can be identified without looking carefully (darkish post-adhesions)

2: Appears cloudy white

1: Cloudy white post-adhesions can be clearly identified (lumps come up if rubbed)

Up to black contaminants of assessment level 3 or higher is compliant.

These results are shown in Table 2.

TABLE 2

| | | | Comparative | Comparative |
|---|---|---|---|---|
| | | Example 1 | Example 1 | Example 2 |
| Methylenebis | | After | Before | Before |
| (fatty acid amide) | | washing with | washing with | washing with |
| composition | | CHCl₃ of (1) | CHCl₃ of (1) | CHCl₃ of (2) |
| Wafer adhesive force | | 0.96 | 0.69 | 0.77 |
| initial value | | | | |
| Tape storage | Adhesive force | 0.69 | 0.74 | 0.44 |
| for 7 days | Contamination | 4 | 2 | 4 |
| at 60° C. | resistance | | | |
| Attachment | Adhesive force | 1.18 | 1.32 | 1.40 |
| and storage | Contamination | 4 | 4 | 4 |
| for 7 days | resistance | | | |
| at 60° C. | | | | |

From the results in Table 2, it is confirm that adhesive force is stable with both the storage in the form of tape and the storage in the form as attached in Example 1 using the methylene bis(fatty acid amide) composition that contains essentially no impurities. Additionally, the contamination resistance is extremely good.

In Comparative Examples 1 and 2 that use the methylenebis(fatty acid amide) compositions substantially including impurities, there is a high increase in adhesive forth during the storage in the form as attached. Moreover, when stored in the form of tape, the adhesive force increased in Comparative Example 1, and by contrast, decreased in Comparative Example 2. In addition, there was extremely high contamination with the storage in the form of tape at a level that would cause problems during use.

### INDUSTRIAL APPLICABILITY

The adhesive sheet according to the present invention enables use in a wide range of application as a sheet for surface protection of various adherends including electronic components, and as a processing or protective sheet or the like during dicing.

1. A methylenebis(fatty acid amide) composition containing as a main component a methylenebis(fatty acid amide) obtained by reacting a fatty acid monoamide with formaldehyde, a content of impurities which consist of the fatty acid monoamide and a fatty acid from which the fatty acid monoamide is constituted is 0 to less than 2 wt %.

2. The methylenebis(fatty acid amide) composition according to claim 1, wherein the methylenebis(fatty acid amide) is a compound represented by Formula (I).
R¹—Am—CH₂—Am—R² (I)
(where in the formula, R¹ and R² independently from one another represent a C₆-C₂₃ saturated or unsaturated hydrocarbon group, and Am represents a secondary amide group.)

3. The methylenebis(fatty acid amide) composition according to claim 1, wherein the methylenebis(fatty acid amide) obtained by reacting the fatty acid monoamide with formaldehyde is one in which impurities which consist of the fatty acid monoamide and the fatty acid from which the fatty acid monoamide is constituted are removed by extraction using a solvent that dissolves the fatty acid monoamide and the fatty acid and does not dissolve the methylenebis(fatty acid amide).

4. A adhesive sheet formed from a thermoplastic resin film on one surface of which is formed a pressure-sensitive adhesive layer, either of the thermoplastic resin film or the pressure-sensitive adhesive layer contains the methylenebis(fatty acid amide) composition of claim 1.

5. The adhesive sheet of claim 4, wherein the methylenebis(fatty acid amide) composition is added at 0.1-3.0 parts by weight based on 100 parts by weight of the thermoplastic resin.

6. The adhesive sheet of claim 4, wherein the thermoplastic resin film is a film made of polyvinyl chloride.

7. The adhesive sheet of claim 4, wherein the thermoplastic resin film further contains an ester plasticizing agent.

8. The adhesive sheet of claim 4, wherein the pressure-sensitive adhesive layer contains an acrylic polymer as a base polymer.

9. The adhesive sheet of claim 4, wherein the pressure-sensitive adhesive layer further contains an ester plasticizing agent.

10. The adhesive sheet of claim 4, wherein the adhesive sheet has an adhesive force toward a silicon wafer of a variable value of within ±0.5 N/20 mm of an initial value after storage.

11. A method for manufacturing an adhesive sheet comprising;
obtaining a methylenebis(fatty acid amide) composition in which the methylenebis(fatty acid amide) obtained by reacting a fatty acid monoamide with formaldehyde is purified by washing with a solvent that dissolves the fatty acid monoamide and a fatty acid from which the fatty acid monoamide is constituted and does not dissolve the methylenebis(fatty acid amide),
forming a thermoplastic resin film or a pressure-sensitive adhesive layer by adding the methylenebis(fatty acid amide) composition as an additive to a resin, and
laminating the thermoplastic resin film and the pressure-sensitive adhesive layer.
